(19) United States
(12) Patent Application Publication
(10) Pub. No.: US 2014/0191709 A1
(43) Pub. Date: Jul. 10, 2014

(54) Handheld Medical Device Simultaneous Charging And In Vivo Analyte Sampling Systems And Methods

(71) Applicant: ROCHE DIAGNOSTICS OPERATIONS, INC., Indianapolis, IN (US)

(72) Inventors: Michael J. Celentano, Fishers, IN (US); Ricky L. Collins, Cicero, IN (US); Clint A. Ecoff, Indianapolis, IN (US)

(73) Assignee: ROCHE DIAGNOSTICS OPERATIONS, INC., Indianapolis, IN (US)

(21) Appl. No.: 13/734,006

(22) Filed: Jan. 4, 2013

(51) Int. Cl. H02J 7/02

(52) U.S. Cl. CPC H02J 7/025
USPC 320/108

(57) ABSTRACT

A handheld medical device that simultaneously charges its re-chargeable battery and measures one or more characteristics of a bodily fluid is taught. The handheld medical device includes a re-chargeable battery, a wireless power receiver, a battery charging module, and a measurement module. The re-chargeable battery is electrically connected to provide power to components of the handheld medical device. The wireless power receiver outputs power received wirelessly, via an antenna, from a wireless power transmitter that is external to the handheld medical device. The battery charging module selectively charges the re-chargeable battery based on the power received wirelessly from the wireless power transmitter. While the handheld medical device is not connected by wire to any other device, the measurement module measures a characteristic of a sample of a bodily fluid simultaneously with the battery charging module charging the re-chargeable battery.

### FIELD

The present disclosure relates to handheld medical devices and more particularly to functionality of handheld medical devices during charging.

### BACKGROUND

Diabetes mellitus, often referred to as diabetes, is a chronic condition in which a person has elevated blood glucose levels that result from defects in the body's ability to produce and/or use insulin. There are three main types of diabetes. Type 1 diabetes usually strikes children and young adults, and can be autoimmune, genetic, and/or environmental. Type 2 diabetes accounts for 90-95% of diabetes cases and is linked to obesity and physical inactivity. Gestational diabetes is a form of glucose intolerance diagnosed during pregnancy and usually resolves spontaneously after delivery.

In 2009, according to the World Health Organization, at least 220 million people worldwide suffer from diabetes. In 2005, an estimated 1.1 million people died from diabetes. The incidence of diabetes is increasing rapidly, and it is estimated that between 2005 and 2030, the number of deaths from diabetes will double. In the United States, nearly 24 million Americans have diabetes with an estimated 25 percent of seniors age 60 and older being affected. The Centers for Disease Control and Prevention forecast that 1 in 3 Americans born after 2000 will develop diabetes during their lifetime. The National Diabetes Information Clearinghouse estimates that diabetes costs $132 billion in the United States alone every year. Without treatment, diabetes can lead to severe complications such as heart disease, stroke, blindness, kidney failure, amputations, and death related to pneumonia and flu.

Management of diabetes is complex because the level of blood glucose entering the bloodstream is dynamic. Variation of insulin in the bloodstream that controls the transport of glucose out of the bloodstream also complicates diabetes management. Blood glucose levels are sensitive to diet and exercise, but also can be affected by sleep, stress, smoking, travel, illness, menses, and other psychological and lifestyle factors that are unique to each patient. The dynamic nature of blood glucose and insulin, and all other factors affecting blood glucose, often require a person with diabetes to forecast blood glucose levels. Administration of insulin and/or oral medications can be regulated and timed to maintain blood glucose levels within an appropriate range at all times.

Management of diabetes is often highly intrusive because of the need to consistently obtain reliable diagnostic information, follow prescribed therapy, and manage lifestyle on a daily basis. Diagnostic information, such blood glucose level, can be obtained from a capillary blood sample with a lancing device and a test strip. The blood glucose level is measured via the test strip using a handheld blood glucose meter. Interstitial glucose levels can be obtained from a continuous glucose sensor worn on the body.

A therapy regimen for a patient can be established based on one or more of the patient's blood glucose levels. The therapy regimen can include administration of insulin and/or oral medication. Insulin can be administered with a syringe, an insulin pen, an ambulatory infusion pump, or a combination of two or more of the above. With insulin therapy, determining the amount of insulin to inject at a given time can require forecasting meal amount and composition (e.g., of fat, carbohydrates, and proteins, and amounts of each). Determining the amount of insulin to inject at a given time can also require consideration of the effects of exercise and physiologic state. The patient's management of lifestyle factors such as body weight, diet, and exercise can significantly influence the type and effectiveness of therapy.

Management of diabetes involves large amounts of diagnostic data and prescriptive data that are acquired from medical devices, personal health care devices, patient recorded information, health care professional tests results, prescribed medications and recorded information. Medical devices including self-monitoring bG meters, continuous glucose monitors, insulin infusion pumps, diabetes analysis software, and diabetes device configuration software each of which generates or manages or both large amounts of diagnostic and prescriptive data. Personal health care devices can include weights, scales, blood pressure cuffs, pedometers, other activity monitors, and other suitable devices. Patient recorded data can include information relating to meals, exercise, and lifestyle. Health care professional biomarker data can include HbA1C, cholesterol, triglycerides, fasting glucose, and glucose tolerance. Health care professional recorded information can include therapy and other patient-specific information.

Handheld diabetes management devices include one or more batteries that can provide power. For example, some handheld diabetes management devices include replaceable, standard size batteries and some handheld diabetes management devices include a non-standard sized, re-chargeable battery.

Handheld diabetes management devices that include a re-chargeable battery generally include provisions for a connection to one or more external power sources for re-charging the battery. For example, a handheld diabetes management device may be connected by wire to a personal computer and/or a wall outlet to charge the re-chargeable battery.

However, because a bodily fluid sample input to a device may provide a current path to the user when a device is receiving power by wire from an external power source, such devices do not measure bodily fluid samples when connected to an external power source by wire. Handheld diabetes management devices may mechanically and/or electrically prevent measurement of bodily fluid samples when connected to an external power source by wire. Thus, there is a need for handheld medical devices that can simultaneously receive power from an external power source and measure bodily fluid samples input to the devices.

The background description provided herein is for the purpose of generally presenting the context of the disclosure. Work of the presently named inventors, to the extent it is described in this background section, as well as aspects of the description that cannot otherwise qualify as prior art at the time of filing, are neither expressly nor impliedly admitted as prior art against the present disclosure.

### SUMMARY

In a feature, a handheld medical device that simultaneously charges its re-chargeable battery and measures one or more characteristics of a bodily fluid is taught. The handheld medical device includes a re-chargeable battery, a wireless power receiver, a battery charging module, and a measurement module. The re-chargeable battery is electrically connected to provide power to components of the handheld medical device. The wireless power receiver outputs power received wirelessly, via an antenna, from a wireless power transmitter that is external to the handheld medical device. The battery charging module selectively charges the re-chargeable battery based on the power received wirelessly from the wireless power transmitter. While the handheld medical device is not connected by wire to any other device, the measurement module measures a characteristic of a sample of a bodily fluid simultaneously with the battery charging module charging the re-chargeable battery.

In other features, a system for monitoring one or more characteristics of a bodily fluid is taught. The system includes: a wireless power transmitter and a handheld medical device. The wireless power transmitter is integrated within a wireless charging device, receives power via a wire that is connected between the wireless charging device and an external power source, and wirelessly outputs power. The handheld medical device includes: a re-chargeable battery that is electrically connected to provide power to components of the handheld medical device; a wireless power receiver that outputs power received wirelessly, via an antenna, from a wireless power transmitter that is external to the handheld medical device; a battery charging module that selectively charges the re-chargeable battery based on the power received wirelessly from the wireless power transmitter; and a measurement module that, while the handheld medical device is not connected by wire to any other device, measures a characteristic of a sample of a bodily fluid simultaneously with the battery charging module charging the re-chargeable battery.

In other features, a method for simultaneously wirelessly transmitting power to a handheld medical device and operating the handheld medical device is taught. The method includes: wirelessly transmitting power to the handheld medical device using an antenna of a wireless charging device; receiving power wirelessly, using an antenna of the handheld medical device, from the wireless charging device; and, simultaneously with the wireless receipt of power from the wireless charging device, measuring, using the handheld medical device, a characteristic of a sample of a bodily fluid while the handheld medical device is not connected by wire to any other device.

In still other features, a system for monitoring one or more characteristics of a bodily fluid is taught. The system includes: a wireless charging device; and a handheld diabetes management device. The wireless charging device includes: a wireless power transmitter that receives power via a wire that is connected between the wireless charging device and an external power source and that wirelessly outputs power via an antenna; a first wireless data transceiver configured to wirelessly receive data via an antenna; and a Universal Serial Bus (USB) controller that transmits the data to a computer over the wire. The handheld diabetes management device cannot be connected to another device or an external power source by wire and includes: a re-chargeable battery; a test strip port for receiving a test strip including a sample of blood; a second wireless data transceiver configured to wirelessly receive data via an antenna; a wireless power receiver that outputs power received wirelessly, via an antenna, from the wireless power transmitter; a battery charging module that selectively charges the re-chargeable battery based on the power received wirelessly from the wireless power transmitter; and a measurement module that measures a characteristic of the sample of blood simultaneously with the battery charging module charging the re-chargeable battery.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a patient and a health care professional along with various devices that can be used to help the patient monitor and control health;

FIG. 2 shows a patient with a continuous glucose monitor (CGM), an ambulatory durable insulin infusion pump, an ambulatory non-durable insulin infusion pump, and a blood glucose (bG) management device;

FIG. 3 shows a diabetes care system of systems that can be used to manage diabetes;

FIG. 4 is a front view of an example implementation of a handheld diabetes management device;

FIG. 5 is a side view of the example diabetes management device;

FIGS. 6-11 are functional block diagrams of example wireless power and data transfer systems including the example diabetes management device;

FIG. 12 is a functional block diagram of an example implementation of the diabetes management device; and

FIG. 13 is a flowchart depicting an example method of controlling power and measuring one or more characteristics of a test strip while receiving power wirelessly.

### DETAILED DESCRIPTION

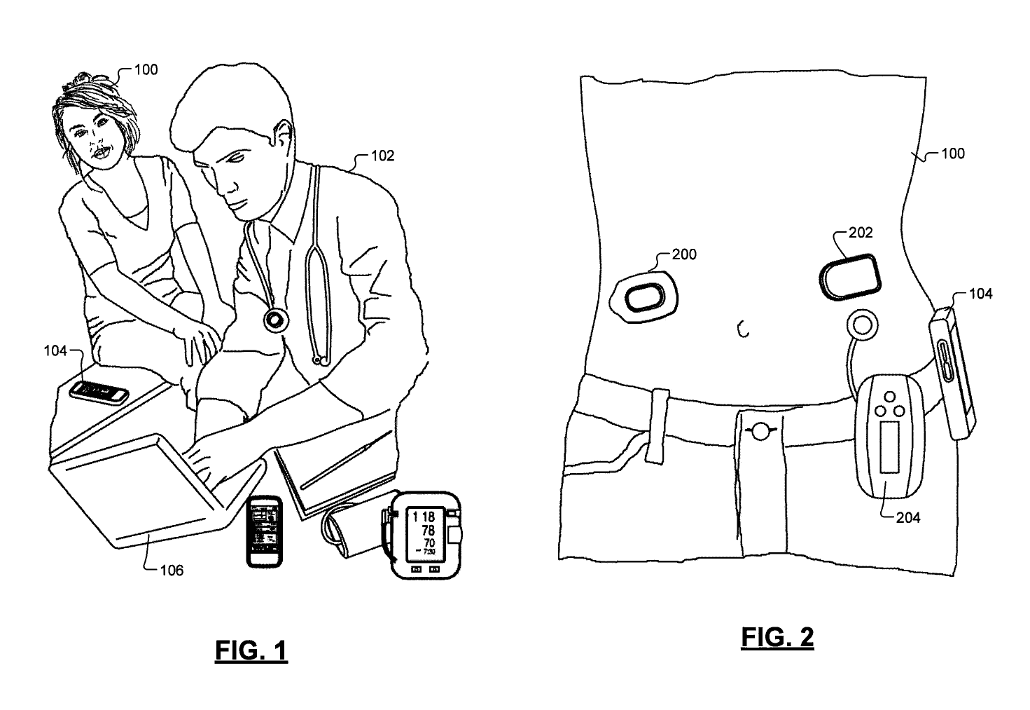

Referring now to FIG. 1, a patient 100 with diabetes and a health care professional 102 are shown in a clinical environment. The patient 100 with diabetes can be diagnosed with a metabolic syndrome, pre-diabetes, type 1 diabetes, type 2 diabetes, gestational diabetes, etc. Healthcare providers for diabetes are diverse and include nurses, nurse practitioners, physicians, endocrinologists, and others and are collectively referred to as health care professionals.

During a health care consultation, the patient 100 typically shares with the health care professional 102 a variety of data including blood glucose (bG) measurements, continuous glucose monitor data, amounts and type of insulin administered, amounts of food and beverages consumed, exercise schedules, health status, and other lifestyle information. The health care professional 102 can obtain additional data for the patient 100, such as measurements of HbA1C, cholesterol levels, plasma glucose, triglycerides, blood pressure, and weight. The data can be recorded manually or electronically on a handheld diabetes management device 104 (e.g., a handheld bG monitor device), a diabetes analysis software executed on a personal computer (PC) 106, and/or a web-based diabetes analysis site.

The health care professional 102 can analyze the patient data manually or electronically using the diabetes analysis software and/or the web-based diabetes analysis site. After analyzing the data and reviewing how efficacious previously prescribed therapy is and how well the patient 100 followed the previously prescribed therapy, the health care professional 102 can decide whether to modify a therapy prescribed for the patient 100.

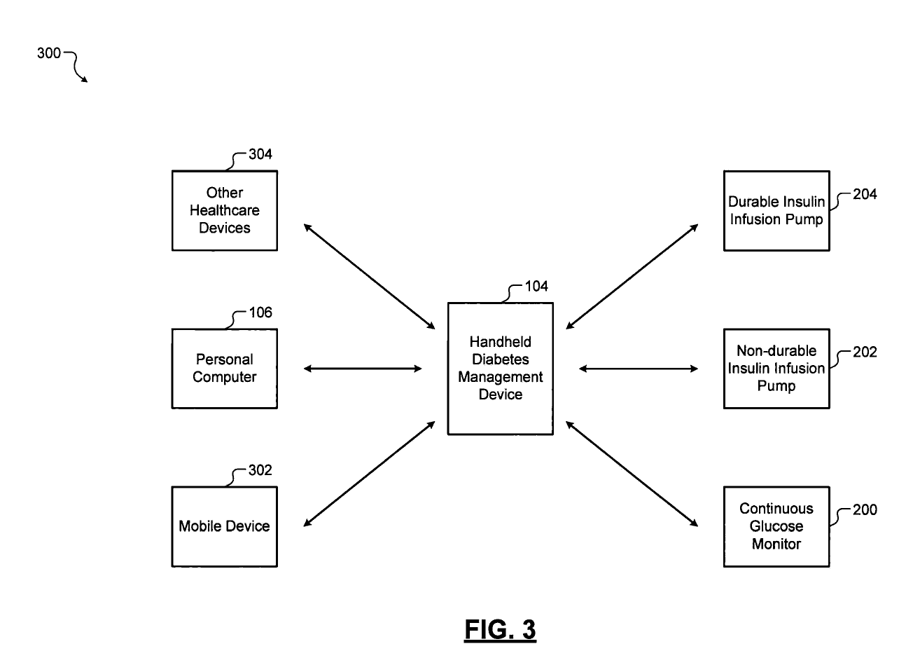

Referring now to FIG. 2, the patient 100 can use a continuous glucose monitor (CGM) 200, an ambulatory durable insulin infusion pump 204 or an ambulatory non-durable insulin infusion pump 202 (collectively insulin pump 204), and the diabetes management device 104. The CGM 200 can use a subcutaneous sensor to sense and monitor the amount of glucose (e.g., glucose concentration) of the patient 100. The CGM 200 communicates glucose measurements to the diabetes management device 104.

The diabetes management device 104 performs various tasks including measuring and recording bG measurements, determining an amount of insulin to be administered to the patient 100 via the insulin pump 204, receiving user input via a user interface, archiving data, performing structured bG tests, etc. The diabetes management device 104 can wirelessly transmit instructions to the insulin pump 204, and the insulin pump 204 selectively delivers insulin to the patient 100. Insulin can be delivered in the form of a meal bolus dose, a correction bolus dose, a basal dose, etc.

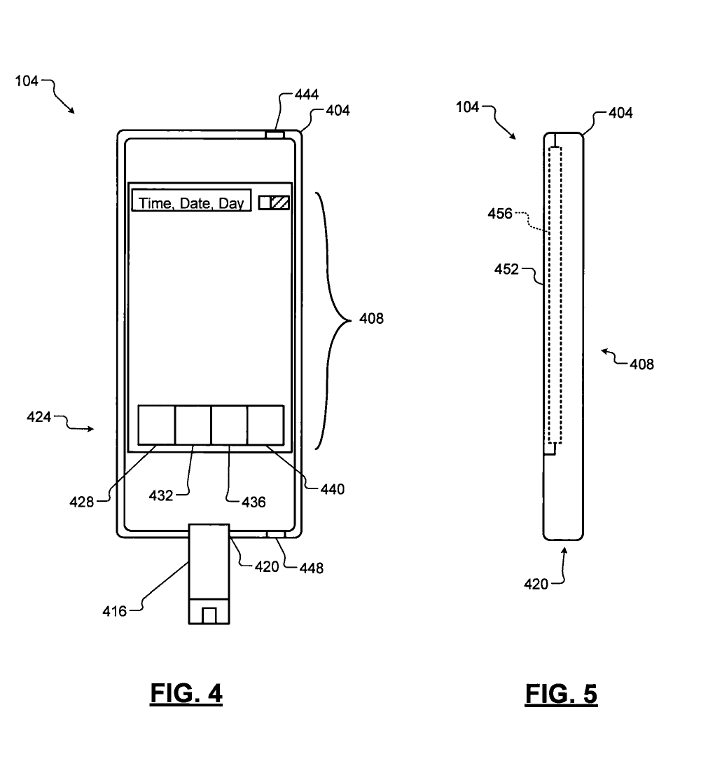

Referring now to FIG. 3, a diabetes management system 300 is shown which can be used by the patient 100 and/or the health care professional 102. The system 300 can include one or more of the following devices: the diabetes management device 104, the CGM 200, the insulin pump 204, a mobile device 302, the diabetes management software (DMS) executed on the computer 106, and one or more other health care devices 304. The diabetes management device 104 can be configured as a system “hub” and communicate with one or more of the other devices of the system 300. The insulin pump 204, the mobile device 302, or another suitable device can alternatively serve as the system hub.

Communication between various devices in the system 300 can be performed using wireless interfaces (e.g., Bluetooth) and/or wired interfaces (e.g., USB). Communication protocols used by these devices can include protocols compliant with the IEEE 11073 standard as extended using guidelines provided by Continua Health Alliance Design Guidelines. Further, health care records systems such as Microsoft HealthVault and Google Health can be used by the patient 100 and the health care professional 102 to exchange information.

The DMS running on the computer 106 can include an analyzer-configurator that stores configuration information for devices of the system 300. For example only, the configurator has a database to store configuration information for the diabetes management device 104 and the other devices. A patient can interface the configurator through standard web based or computer graphical user interfaces (GUIs). The configurator selectively transmits patient-approved configurations to the devices of the system 300. The analyzer selectively retrieves data from the devices of the system 300, stores the data in a database, selectively analyzes the data, and outputs analysis results through standard web based or computer GUIs.

Referring now to FIG. 4, a high level illustration of an example embodiment of the diabetes management device 104 is presented. While the present application will be discussed in conjunction with the diabetes management device 104, the present application is also applicable to other types of handheld medical devices and partially implantable medical devices that measure samples of bodily fluid. Other types of handheld medical devices include, but are not limited to, handheld triglyceride management devices, handheld cholesterol management devices, handheld coagulation management devices, and handheld analyte management devices. Partially implantable medical devices may refer to medical devices that are at least partially implantable within a user but that are not completely implanted. For example, partially implantable medical devices include continuous glucose monitors, insulin pumps, and other types of partially implantable medical devices.

The diabetes management device 104 includes, among other things, a housing 404, user unit control switches (not specifically numbered), a touchscreen display 408, and a bG test strip port 420. The user unit control switches, for example, can include ON/OFF switches, volume switches, alarm switches for bG testing and/or insulin administration, and/or one or more other switches or other types of control devices that a patient can use to control functions/operations of the diabetes management device 104.

A blood sample can be added to a bG test strip 416, and the bG test strip 416 can be inserted into the bG test strip port 420. The bG test strip 416 can be inserted into the bG test strip port 420 by a patient, from a test strip drum (not shown) located within the housing 404, or in another suitable manner. The bG test strip 416 is shown already inserted into the bG test strip port 420 in the example of FIG. 4.

User selectable options 424 can be displayed on a portion of the display 408. The selectable options 424 can include a menu option 428, a bolus insulin option 432, a carbohydrate option 436, and an event option 440. One or more other user selectable options can additionally or alternatively be available. A user can access a device menu for the diabetes management device 104 by selecting the menu option 428. A user can input various insulin (and/or other medication) information (e.g., amount, insulin type, etc.) by selecting the bolus insulin option 432. A user can input various carbohydrate intake information (e.g., amount) by selecting the carbohydrate option 436. A user can also input other food intake information (e.g., protein content, fat content, etc.) by selecting the carbohydrate option 436. A user can input various event related information (e.g., meals, exercise, periods of stress, etc.) that can affect the patient's bG measurements by selecting the event option 440. A user may access and view a history of events (e.g., of bG measurements, exercise, carbohydrate intake, insulin administration, etc.) via the menu option 428.

Although the display 408 is described herein as a touchscreen display, the diabetes management device 104 can include another suitable type of display (e.g., LED, etc.). If a touchscreen display is not used, the user control switches can include specific buttons or controls by which a user is able to select various options and input markers needed to operate the diabetes management device 104. The diabetes management device 104 may include one or more visual indicators, such as LED 444. The diabetes management device 104 may include one or more audio output devices, such as speaker 448.

FIG. 5 includes a side view of the example diabetes management device 104. Referring now to FIGS. 4 and 5, the diabetes management device 104 may include a battery compartment 452 for housing a re-chargeable battery 456. The battery 456 may include, for example, a lithium based (e.g., lithium ion) battery or another suitable type of re-chargeable battery. The diabetes management device 104 can operate using power from the battery 456.

In various implementations, the diabetes management device 104 does not include a port for and cannot receive power by wire from an external power source. Accordingly, a wire cannot be connected directly to the diabetes management device 104 and an external power source. The non-inclusion of such a port may render taking measurements of samples easier as user confusion as to which port to insert the sample may be eliminated. In other implementations, a port may be included for receiving power by wire from an external power source.

One or more regulatory requirements may require a set amount of electrical isolation be present between external power sources (e.g., wall outlets) and users of handheld medical devices. However, a bodily fluid sample input to a medical device may provide a current path between a user and an external power source when a handheld medical device is receiving power by wire from the external power source. The present application teaches systems and methods that enable handheld medical devices to receive power and wirelessly communicate simultaneously with measuring characteristics of a bodily fluid sample.

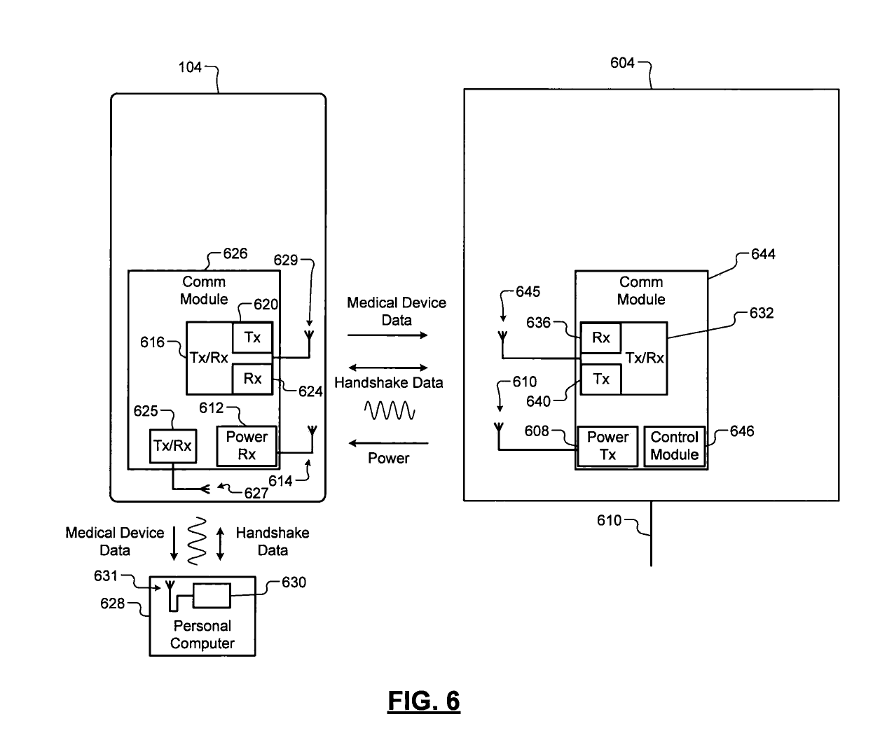

Referring now to FIG. 6, a functional block diagram of an example wireless power and data transfer system is presented. The diabetes management device 104 receives power wirelessly from a wireless charging device 604. The wireless charging device 604 includes a power transmitter (Tx) 608 that receives power from an external power source via a wire/cable 610. As discussed further below, the external power source may be an alternating current (AC) power source, such as a wall outlet, or a Universal Serial Bus (USB) power source.

The power transmitter 608 wirelessly transmits power based on the power received from the external power source. The power transmitter 608 transmits power wirelessly via an antenna 610. The diabetes management device 104 includes a power receiver (Rx) 612 that receives power from the power transmitter 608 and that outputs power for the diabetes management device 104 (e.g., battery charging, operation, etc.) based on power received from the power transmitter 608. The power receiver 612 receives power wirelessly via an antenna 614. For example, the wireless power transmission and receipt may be inductive power transmission and receipt, capacitive power transmission and receipt, radio frequency (RF) power transmission and receipt, or another suitable type of wireless power transmission and receipt.

Wireless power transmission and receipt provides galvanic isolation between the external power source and the diabetes management device 104. Because the diabetes management device 104 is isolated from the external power source, the diabetes management device 104 can measure one or more characteristics of a sample of a bodily fluid simultaneously with receiving power from the wireless charging device 604 and/or data transfer to a personal computer.

The diabetes management device 104 also includes a wireless data transceiver 616. The wireless data transceiver 616 includes a transmitter 620 and a receiver 624. In various implementations, the power receiver 612 and the wireless data transceiver 616 may be implemented as a single module, such as a communications module 626.

The diabetes management device 104 may wirelessly communicate with a personal computer 628 executing the DMS (diabetes management software) via the wireless data transceiver 616 or another wireless data transceiver 625. The wireless data transceiver 616 may wirelessly communicate via one or more antennas, such as an antenna 629.

For example, the diabetes management device 104 may wirelessly transmit data to the personal computer 628 that is indicative of measurements of samples measured by the diabetes management device 104 and/or other suitable data stored on the diabetes management device 104 (medical device data). The diabetes management device 104 and the personal computer 628 may also wirelessly communicate to perform a handshake process (e.g., an automated process of negotiation) before transmitting the medical device data and/or other data. The wireless data transceiver 616 may transmit and receive data, for example, in accordance with a Bluetooth standard (e.g., the Bluetooth Low Energy (BLE) standard), infrared (IR), or another suitable wireless data transmission standard. The personal computer 628 may include a wireless data transceiver 630 that transmits and receives data in accordance with the same standard as the wireless data transceiver 616. The wireless data transceiver 625 may wirelessly communicate via one or more antennas, such as an antenna 627. The wireless data transceiver 630 may wirelessly communicate via one or more antennas, such as an antenna 631.

The wireless charging device 604 may also include a wireless data transceiver 632. The wireless data transceiver 632 includes a transmitter 636 and a receiver 640. In various implementations, the power transmitter 608 and the wireless data transceiver 632 may be implemented as a single module, such as a communications module 644. The wireless data transceiver 632 may transmit and receive data in accordance with the same standard as the wireless data transceiver 616. The wireless data transceiver 632 may wirelessly communicate via one or more antennas, such as antenna 645. The wireless charging device 604 may also include a control module 646 that controls the wireless power transmitter 608 and/or the wireless data transceiver 632. The diabetes management device 104 and the personal computer 628 may also wirelessly communicate to perform a handshaking (authentication) process before wirelessly transmitting power to the diabetes management device 104 and/or before transmitting the medical device data and/or other data.

When the diabetes management device 104 cannot wirelessly communicate with the personal computer 628, the diabetes management device 104 may wirelessly communicate the medical device data to the personal computer 628 via the wireless charging device 604. More specifically, the diabetes management device 104 may wirelessly communicate the medical device data to the wireless data transceiver 632, and the wireless charging device 604 may communicate the medical device data to the personal computer 628 over the wire 610. The diabetes management device 104 may be unable to wirelessly communicate with the personal computer 628, for example, if the personal computer 628 does not include the wireless data transceiver 630, the diabetes management device 104 is out of range of the personal computer 628, and/or under other circumstances.

The power receiver 612 may awake or be woken up at periodic intervals to determine whether the power receiver 612 is receiving power from the power transmitter 608. Additionally or alternatively, the receipt of power by the power receiver 612 may wake up the power receiver 612. Charging of the battery 456 and/or a wireless data transfer may be performed when the power receiver 612 receives power from the power transmitter 608.

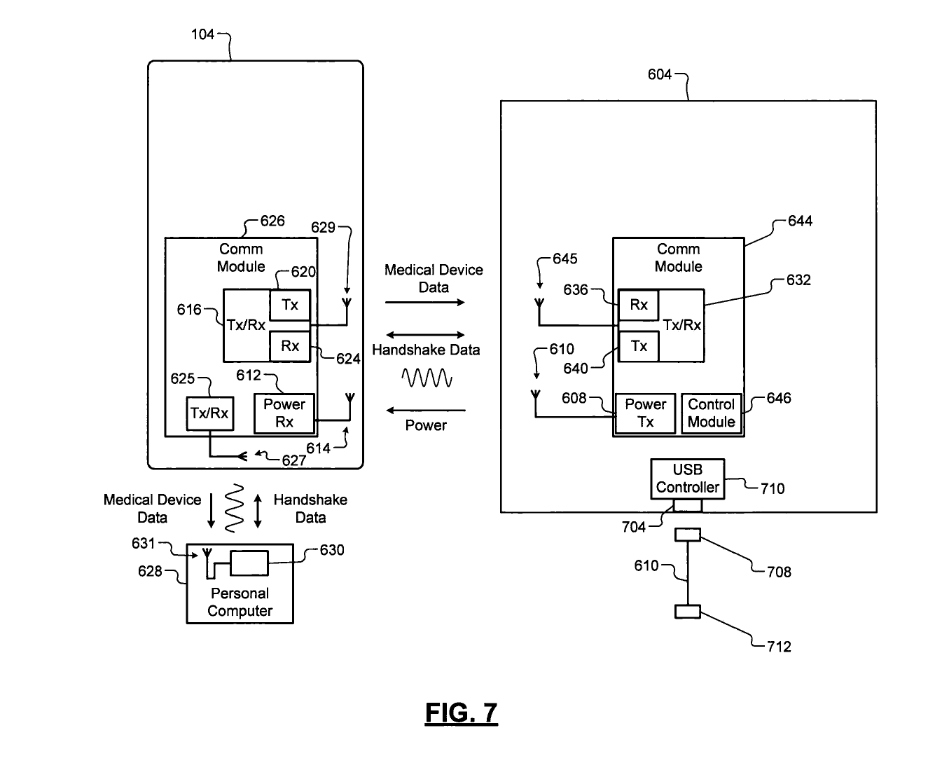

As shown in FIG. 6, the wire 610 may be integrated with the wireless charging device 604 such that conductors of the wire 610 are directly connected to components of the wireless charging device 604. Alternatively, as shown in FIG. 7, the wireless charging device 604 may include a port 704. In such implementations, the wire 610 includes a first connector 708. The port 704 and the first connector 708 may be configured in accordance with a USB standard, such as the USB 1.x, 2.x, or 3.x standards or another suitable standard. The port 704 and the first connector 708 may include, for example, standard, mini, or micro type USB connectors. The components of the wireless charging device 604 may be electrically connected to the port 704 via a USB controller 710.

As also shown in FIG. 7, the wire 610 may also include a second connector 712. The second connector 712 may also be configured in accordance with a USB standard, such as the USB 1.x, 2.x, or 3.x standards or another suitable standard. The second connector 712 may include, for example, a standard, mini, or micro type USB connector.

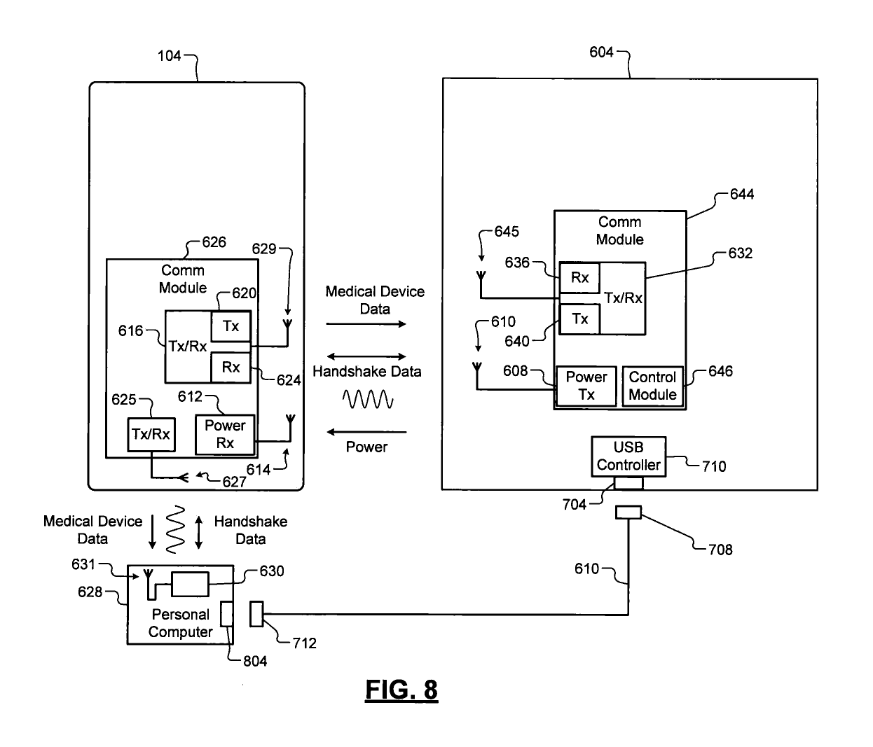

As shown in FIG. 8, the second connector 712 may be connected to a port 804 of the personal computer 628. The port 804 is configured in accordance with the same standard and has the same type of connector as the second connector 712. In such implementations, the power transmitter 608 can receive power from the personal computer 628 via the wire 610.

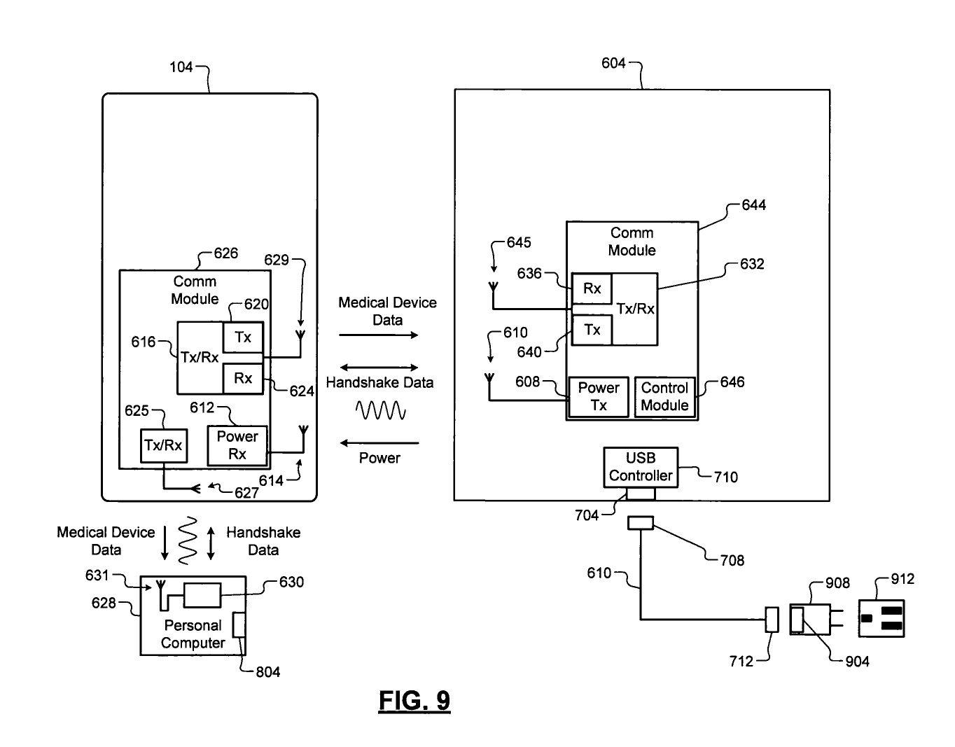

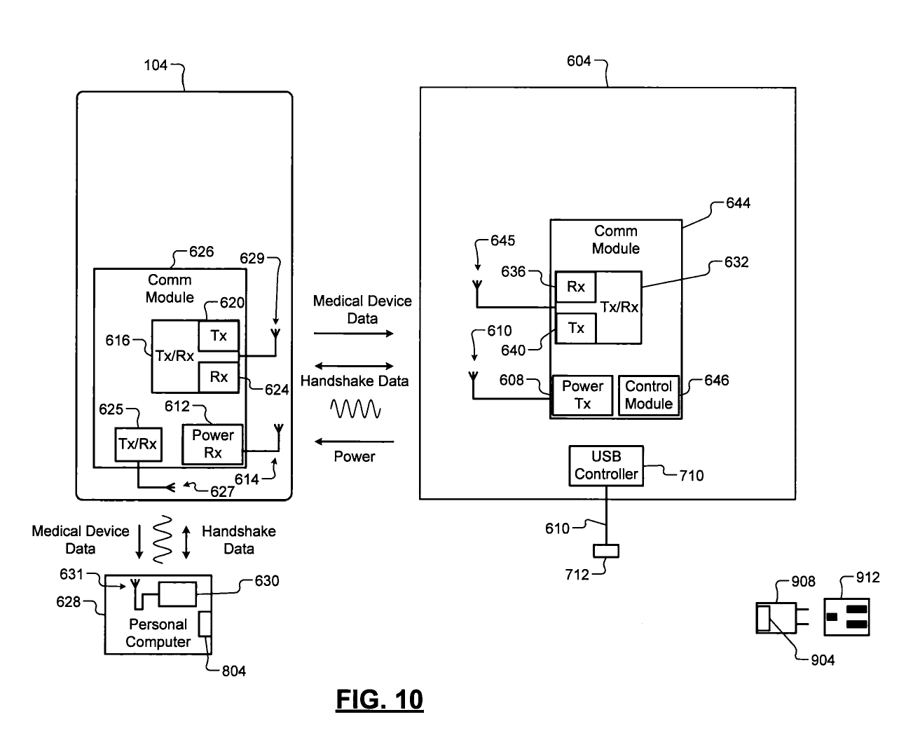

As shown in FIG. 9, the second connector 712 can also be connected to a port 904 of a wall outlet adapter 908. The port 904 is configured in accordance with the same standard and has the same type of connector as the second connector 712. In such implementations, the power transmitter 608 receives power from a power outlet, such as a standard wall outlet 912, via the wire 610.

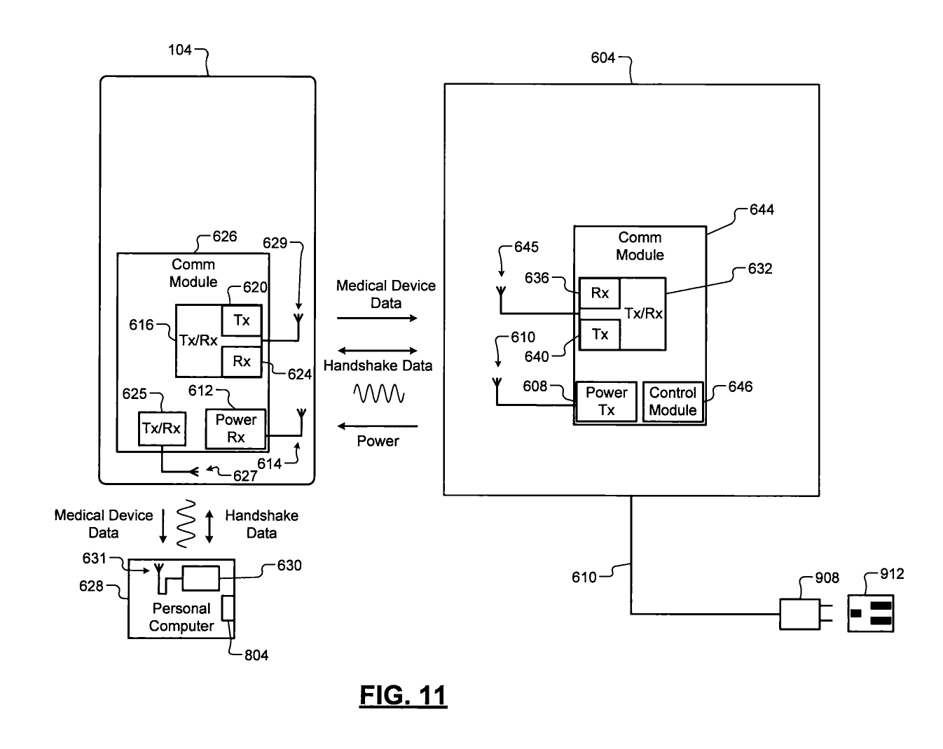

As shown in FIG. 10, the first connector 708 may be omitted, the wire 610 may be integrated with the USB controller 710, and the wire 610 may include the second connector 712. As described above, the wireless charging device 604 can therefore receive power via connection of the second connector 712 to the personal computer 628 or connection of the second connector 712 to the wall outlet adapter 908. As shown in FIG. 11, the wire 610 may be integrated with the wireless charging device 604 and the wall outlet adapter 908.

In various implementations, the wireless charging device 604 may take the form factor (design and geometry) of a mouse pad. Useful information can be provided on outer surfaces of the wireless charging device 604. For example, the useful information may include customer support information, supply order information, an indicator of a location for optimum wireless power transmission and receipt and/or wireless data transfer, and other information that may be useful to a user.

In various implementations, the wireless charging device 604 and/or the diabetes management device 104 may include one or more holding members. The one or more holding members are configured to help achieve a predetermined spatial relationship between the diabetes management device 104 and the wireless charging device 604. The predetermined spatial relationship may be maintained, for example, to optimize wireless power transmission and receipt and/or wireless data transfer.

For example only, the wireless charging device 604 and the diabetes management device 104 may each include one or more magnetic devices that are polarized as to attract the diabetes management device 104 toward achieving the predetermined spatial relationship. For another example only, the wireless charging device 604 may include one or more male members and the wireless charging device 604 may include one or more female members, or vice versa, for achieving the predetermined spatial relationship when the male member(s) is/are inserted into the female members. For another example only, the wireless charging device 604 may take the form factor of a cradle for the diabetes management device 104.

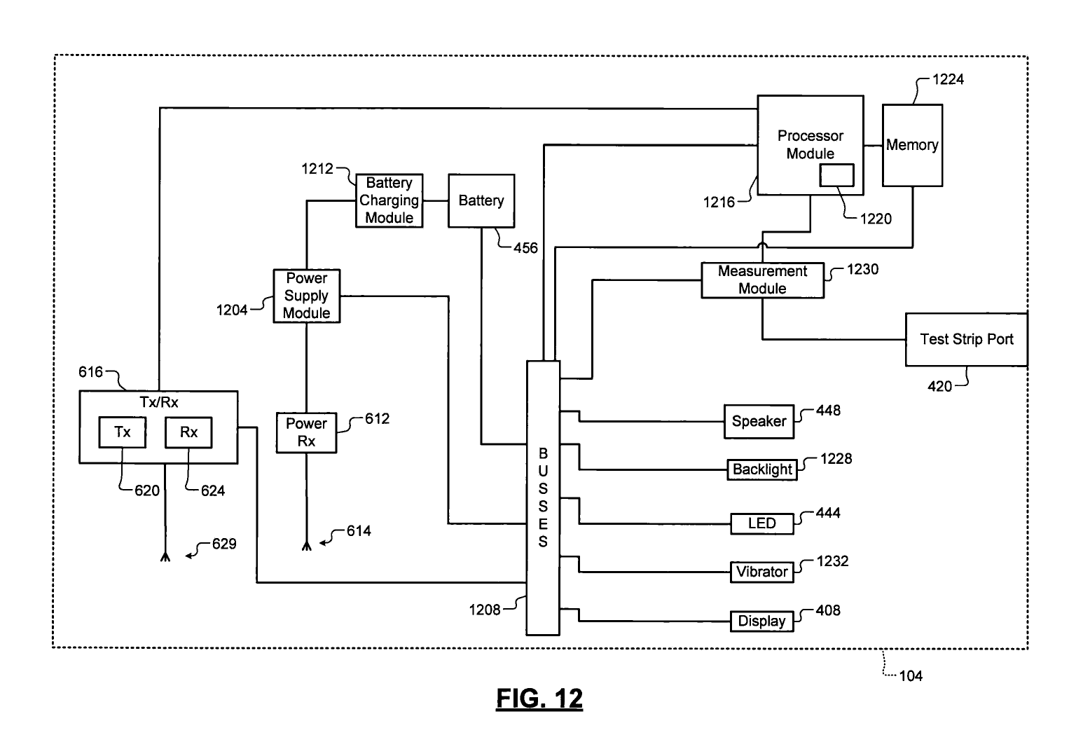

Referring now to FIG. 12, a functional block diagram of an example implementation of the diabetes management device 104 is presented. As stated above, while the diabetes management device 104 is shown and discussed, the present application is also applicable to other types of handheld medical devices and partially implantable medical devices including, but not limited to, handheld triglyceride management devices, handheld cholesterol management devices, handheld coagulation management devices, handheld analyte management devices, continuous glucose monitors, and insulin pumps.

The power receiver 612 outputs power to a power supply module 1204 based on power received wirelessly from the power transmitter 608. The power supply module 1204 may supply power to a voltage bus 1208 and/or a battery charging module 1212 based on power received from the power receiver 612. The battery 456 may additionally or alternatively provide power to the voltage bus 1208. While only the voltage bus 1208 is shown, the voltage bus 1208 is representative of both a voltage bus and a data bus.

The diabetes management device 104 includes a processor module 1216 that includes a processor 1220. For example only, the processor module 1216 may be an i.MX233 applications processor module or another suitable processor module. Code for executing the functionality of the diabetes management device 104 is stored in memory 1224. While the memory 1224 is shown as being external to the processor module 1216, the memory 1224 may be wholly or partially integrated within the processor module 1216.

The battery charging module 1212 selectively charges the battery 456 with power received from the power transmitter 608. The battery charging module 1212 controls current flow to the battery 456. The battery charging module 1212 may monitor one or more parameters, such as current flow to and/or from the battery 456, a voltage of the battery 456, one or more temperatures of the battery 456, and/or other suitable parameters. The battery charging module 1212 may determine a state of charge (SOC) of the battery 456 based on one or more of the monitored parameters.

The battery charging module 1212 controls current flow to the battery 456 based on a target current. Additionally or alternatively, the battery charging module 1212 may control current flow to the battery 456 based on the SOC of the battery 456 and/or one or more other parameters. For example, the battery charging module 1212 may determine a predetermined value for the target current, and the processor module 1216 may determine a present amount of power being consumed for operation of the diabetes management device 104. The battery charging module 1212 may decrease the target current from the predetermined value based on the present amount of power being consumed for operation of the diabetes management device 104. The battery charging module 1212 may determine the predetermined value for the target current, for example, as a function of temperature of the battery 456, voltage of the battery 456, the SOC of the battery 456, and/or one or more other suitable parameters.

The diabetes management device 104 includes a measurement module 1230. The measurement module 1230 measures one or more characteristics of a sample of a bodily fluid. For example, in the case of a bG management device, the measurement module 1230 measures bG of a sample of blood present on a bG test strip that is inserted into the bG test strip port 420. The measurement module 1230 may generate sample data based on the characteristics of the sample and provide the sample data to the processor module 1216. The processor module 1216 may store the sample data and other data (e.g., user input data and other types of data) in memory 1224. Data stored in memory 1224 may selectively be transmitted to the personal computer 628 via the wireless data transceiver 616. While only the wireless data transceiver 616 is shown, the diabetes management device 104 may also include the wireless data transceiver 625.

The diabetes management device 104 also includes a plurality of components for communicating between the diabetes management device 104 and one of a user of the diabetes management device 104 and another device (e.g., an insulin pump, a CGM, a computer, etc.). The components that communicate between the diabetes management device 104 and one of a user of the diabetes management device 104 and another device will be referred to as communication components. While examples of communication components are provided, the diabetes management device 104 may include other types of components that communicate information from the diabetes management device 104 to one of a user of the diabetes management device 104 and another device.

For example, the diabetes management device 104 includes the display 408 and one or more visual indicators, such as the LED 444, that communicate information to a user of the diabetes management device 104. The diabetes management device 104 may also include a backlight 1228 that backlights the display 408 for facilitating communication of information to a user. The diabetes management device 104 may also include a vibrator device 1232 which vibrates to communicate information to a user. The diabetes management device 104 also includes the wireless data transceiver 616 for wirelessly communicating with other devices, such as the personal computer 628 or the wireless charging device 604.

The processor module 1216 may control operation of the wireless data transceiver 616. The processor module 1216 may control operation of the backlight 1228. The processor module 1216 may control operation of the LED 444. The processor module 1216 may control operation of the vibrator device 1232 The processor module 1216 may control operation of the display. The processor module 1216 may control operation of the speaker 448. The processor module 1216 may control operation of the measurement module 1230.

The processor module 1216 may be directly connected the voltage bus 1208, and the power supply module 1204 may output power received wirelessly to the voltage bus 1208 at a first time after the power receiver 612 begins receiving power. In this manner, the processor module 1216 may be operable and functionality of the diabetes management device 104 may be available beginning shortly after the power receiver 612 begins receiving power wirelessly.

For example, the measurement module 1230 may be able to measure the characteristic of a sample of bodily fluid shortly after the power receiver 612 begins receiving power. The power supply module 1204 may output power to the battery charging module 1212 beginning at a second time that is after the first time. In other words, the power supply module 1204 may enable measurement of a sample of bodily fluid before the battery charging module 1212 can begin charging the battery 456.

The measurement module 1230 can measure the characteristic(s) of a sample of a bodily fluid simultaneously with the diabetes management device 104 receiving power wirelessly from the wireless charging device 604. The measurement module 1230 can also measure the characteristic(s) of a sample simultaneously with the battery charging module 1212 charging the battery 456 based on power received wirelessly from the wireless charging device 604. The measurement module 1230 can also measure the characteristic(s) of a sample simultaneously with the wireless data transceiver 616 wirelessly communicating directly with the personal computer 628 or with the personal computer 628 via the wireless charging device 604.

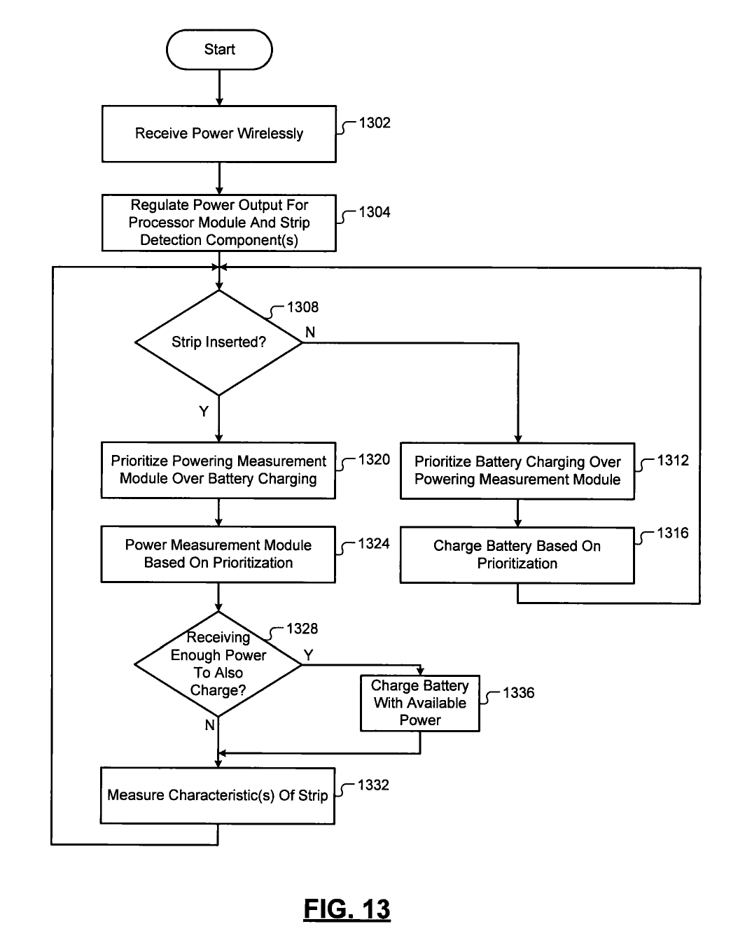

Referring now to FIG. 13, a flowchart depicting an example method that may be performed by the diabetes management device 104 is presented. Control may begin with 1302 where the wireless power receiver 612 begins receiving power wirelessly from the wireless power transmitter 608. The wireless power transmitter 608 may begin wirelessly outputting power after a handshaking process is performed in various implementations.

At 1304, the power supply module 1204 begins outputting power to the processor module 1216 and other components that may be used to detect whether a bG test strip is present within the bG test strip port 420. The power supply module 1204 may output power to the processor module 1216 and other components of the diabetes management device 104 via the voltage bus 1208. At 1308, the processor module 1216 determines whether a bG test strip is present within the bG test strip port 420. If false, control may continue with 1312; if true, control may continue with 1320, which is discussed further below.

At 1312, the processor module 1216 may prioritize battery charging over powering the measurement module 1230. Based on this prioritization of battery charging, the power supply module 1204 may provide an increased the amount of power to the battery charging module 1212 at 1316. In this manner, more power may be provided for battery charging and less power may be provided for operation of the diabetes management device 104. The battery charging module 1212 selectively charges the battery 456 based on power output by the power supply module 1204. Control may return to 1308.

At 1320, the processor module 1216 may prioritize powering the measurement module 1230 for measuring the characteristic(s) of the strip over battery charging. As such, the power supply module 1204 outputs power for operation of the measurement module 1230 at 1324. At 1328, the processor module 1216 may determine whether enough power is being received to also (i.e., in addition to powering the measurement module 1230) charge the battery 456. If false, the measurement module 1230 measures the characteristic(s) of the strip at 1332, and control may return to 1308. If true, the power supply module 104 may provide some or all of the power available (the power being received in excess of that necessary to power the measurement module 1230) to the battery charging module 1212. The battery charging module 1212 selectively charges the battery 456 based on power output by the power supply module 1204. In this manner, less or zero power may be provided for battery charging and more power may be provided for operation of the diabetes management device 104. The measurement module 1230 measures the characteristic(s) of the strip at 1332, and control may return to 1308.

In a feature, a handheld medical device that simultaneously charges its re-chargeable battery and measures one or more characteristics of a bodily fluid is taught. The handheld medical device includes a re-chargeable battery, a wireless power receiver, a battery charging module, and a measurement module. The re-chargeable battery is electrically connected to provide power to components of the handheld medical device. The wireless power receiver outputs power received wirelessly, via an antenna, from a wireless power transmitter that is external to the handheld medical device. The battery charging module selectively charges the re-chargeable battery based on the power received wirelessly from the wireless power transmitter. While the handheld medical device is not connected by wire to any other device, the measurement module measures a characteristic of a sample of a bodily fluid simultaneously with the battery charging module charging the re-chargeable battery.

In further features, the measurement module measures blood glucose (bG) of the bodily fluid sample simultaneously with the battery charging module charging the re-chargeable battery.

In still further features, the measurement module measures cholesterol of the bodily fluid sample simultaneously with the battery charging module charging the re-chargeable battery.

In further features, the measurement module measures coagulation of the bodily fluid sample simultaneously with the battery charging module charging the re-chargeable battery.

In still further features, the measurement module measures triglycerides of the bodily fluid sample simultaneously with the battery charging module charging the re-chargeable battery.

In further features, the handheld medical device further includes a wireless data transmitter that wirelessly transmits data indicative of the characteristic of the bodily fluid sample to a wireless charging device including the wireless power transmitter.

In still further features, a system includes the handheld medical device and the wireless charging device. The wireless charging device transmits the data to a computer via a wire.

In further features, the handheld medical device further includes a power supply module that receives the power output by the wireless power receiver, that begins powering the measurement module at a first time after the wireless power receiver begins receiving power wirelessly, and that begins powering one or more components of the handheld medical device other than the measurement module at a second time after the wireless power receiver begins receiving power wirelessly, wherein the second time is after the first time.

In still further features, the handheld medical device cannot be connected to another device or an external power source by wire.

In other features, a system for monitoring one or more characteristics of a bodily fluid is taught. The system includes: a wireless power transmitter and a handheld medical device. The wireless power transmitter is integrated within a wireless charging device, receives power via a wire that is connected between the wireless charging device and an external power source, and wirelessly outputs power. The handheld medical device includes: a re-chargeable battery that is electrically connected to provide power to components of the handheld medical device; a wireless power receiver that outputs power received wirelessly, via an antenna, from a wireless power transmitter that is external to the handheld medical device; a battery charging module that selectively charges the re-chargeable battery based on the power received wirelessly from the wireless power transmitter; and a measurement module that, while the handheld medical device is not connected by wire to any other device, measures a characteristic of a sample of a bodily fluid simultaneously with the battery charging module charging the re-chargeable battery.

In further features, the wire is configured in accordance with a universal serial bus (USB) standard.

In still further features, the wireless power transmitter wirelessly outputs and the wireless power receiver wirelessly receives radio frequency (RF) power.

In further features, the wireless power transmitter and the wireless power receiver are inductively coupled.

In still further features, the wireless power transmitter and the wireless power receiver are capacitively coupled.

In further features, the system further includes a wireless data transceiver that is integrated within the wireless charging device. The handheld medical device further includes a wireless data transmitter that wirelessly transmits data indicative of the characteristic of the sample to the wireless data transceiver.

In still further features, the wireless data transceiver transmits the data to a computer over the wire.

In further features, the wireless charging device further comprises a holding member for maintaining a predetermined spatial relationship between the handheld medical device and the wireless charging device.

In still further features, the handheld medical device further includes a second holding member for maintaining the predetermined spatial relationship between the handheld medical device and the wireless charging device.

In further features, at least one of the holding member and the second holding member includes a magnetic member.

In other features, a method for simultaneously wirelessly transmitting power to a handheld medical device and operating the handheld medical device is taught. The method includes: wirelessly transmitting power to the handheld medical device using an antenna of a wireless charging device; receiving power wirelessly, using an antenna of the handheld medical device, from the wireless charging device; and, simultaneously with the wireless receipt of power from the wireless charging device, measuring, using the handheld medical device, a characteristic of a sample of a bodily fluid while the handheld medical device is not connected by wire to any other device.

In still other features, a system for monitoring one or more characteristics of a bodily fluid is taught. The system includes: a wireless charging device; and a handheld diabetes management device. The wireless charging device includes: a wireless power transmitter that receives power via a wire that is connected between the wireless charging device and an external power source and that wirelessly outputs power via an antenna; a first wireless data transceiver configured to wirelessly receive data via an antenna; and a Universal Serial Bus (USB) controller that transmits the data to a computer over the wire. The handheld diabetes management device cannot be connected to another device or an external power source by wire and includes: a re-chargeable battery; a test strip port for receiving a test strip including a sample of blood; a second wireless data transceiver configured to wirelessly receive data via an antenna; a wireless power receiver that outputs power received wirelessly, via an antenna, from the wireless power transmitter; a battery charging module that selectively charges the re-chargeable battery based on the power received wirelessly from the wireless power transmitter; and a measurement module that measures a characteristic of the sample of blood simultaneously with the battery charging module charging the re-chargeable battery.

The above description is a broad description of a diabetes management device. In practice, the diabetes management device can include additional controls, etc., as can be desired to further enhance its utility or its use with other components and devices (e.g., computers, infusion pumps, cellular phones, etc.). The description of the diabetes management device should not be taken as limiting as to the construction of the diabetes management device or as to the features and capabilities of the diabetes management device.

As used herein, the term “module” can refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term “module” can include memory (shared, dedicated, or group) that stores code executed by the processor.

The term “code,” as used above, can include software, firmware, and/or microcode, and can refer to programs, routines, functions, classes, and/or objects. The term “shared,” as used above, means that some or all code from multiple modules can be executed using a single (shared) processor. In addition, some or all code from multiple modules can be stored by a single (shared) memory. The term “group,” as used above, means that some or all code from a single module can be executed using a group of processors. In addition, some or all code from a single module can be stored using a group of memories.

The apparatuses and methods described herein can be implemented by one or more computer programs executed by one or more processors. The computer programs include processor-executable instructions that are stored on a non-transitory, tangible, computer readable medium. The computer programs can also include stored data. Examples of the non-transitory, tangible, computer readable medium include, but are not limited to, nonvolatile memory, volatile memory, magnetic storage, and optical storage.

The description is merely illustrative in nature and is in no way intended to limit the disclosure, its application, or uses. For purposes of clarity, the same reference numbers may be used in the drawings to identify similar elements. As used herein, the phrase at least one of A, B, and C should be construed to mean a logical (A or B or C), using a non-exclusive logical or. It should be understood that steps within a method can be executed in different order without altering the principles of the present disclosure.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A handheld medical device that simultaneously charges its re-chargeable battery and measures one or more characteristics of a bodily fluid, the handheld medical device comprising:
a re-chargeable battery that is electrically connected to provide power to components of the handheld medical device;
a wireless power receiver that outputs power received wirelessly, via an antenna, from a wireless power transmitter that is external to the handheld medical device;
a battery charging module that selectively charges the re-chargeable battery based on the power received wirelessly from the wireless power transmitter; and
a measurement module that, while the handheld medical device is not connected by wire to any other device, measures a characteristic of a sample of a bodily fluid simultaneously with the battery charging module charging the re-chargeable battery.

2. The handheld medical device of claim 1 wherein the measurement module measures blood glucose (bG) of the bodily fluid sample simultaneously with the battery charging module charging the re-chargeable battery.

3. The handheld medical device of claim 1 wherein the measurement module measures cholesterol of the bodily fluid sample simultaneously with the battery charging module charging the re-chargeable battery.

4. The handheld medical device of claim 1 wherein the measurement module measures coagulation of the bodily fluid sample simultaneously with the battery charging module charging the re-chargeable battery.

5. The handheld medical device of claim 1 wherein the measurement module measures triglycerides of the bodily fluid sample simultaneously with the battery charging module charging the re-chargeable battery.

6. The handheld medical device of claim 1 further comprising a wireless data transmitter that wirelessly transmits data indicative of the characteristic of the bodily fluid sample to a wireless charging device including the wireless power transmitter.

7. A system comprising:
the handheld medical device of claim 6; and
the wireless charging device,
wherein the wireless charging device transmits the data to a computer via a wire.

8. The handheld medical device of claim 1 further comprising a power supply module that receives the power output by the wireless power receiver, that begins powering the measurement module at a first time after the wireless power receiver begins receiving power wirelessly, and that begins powering one or more components of the handheld medical device other than the measurement module at a second time after the wireless power receiver begins receiving power wirelessly, wherein the second time is after the first time.

9. The handheld medical device of claim 1 wherein the handheld medical device cannot be connected to another device or an external power source by wire.

10. A system for monitoring one or more characteristics of a bodily fluid, the system comprising:
a wireless power transmitter that is integrated within a wireless charging device, that receives power via a wire that is connected between the wireless charging device and an external power source, and that wirelessly outputs power; and
a handheld medical device comprising:
a re-chargeable battery that is electrically connected to provide power to components of the handheld medical device;
a wireless power receiver that outputs power received wirelessly, via an antenna, from a wireless power transmitter that is external to the handheld medical device;
a battery charging module that selectively charges the re-chargeable battery based on the power received wirelessly from the wireless power transmitter; and
a measurement module that, while the handheld medical device is not connected by wire to any other device, measures a characteristic of a sample of a bodily fluid simultaneously with the battery charging module charging the re-chargeable battery.

11. The system of claim 10 wherein the wire that is configured in accordance with a universal serial bus (USB) standard.

12. The system of claim 10 wherein the wireless power transmitter wirelessly outputs and the wireless power receiver wirelessly receives radio frequency (RF) power.

13. The system of claim 10 wherein the wireless power transmitter and the wireless power receiver are inductively coupled.

14. The system of claim 10 wherein the wireless power transmitter and the wireless power receiver are capacitively coupled.

15. The system of claim 10 further comprising a wireless data transceiver that is integrated within the wireless charging device,
wherein handheld medical device further comprises a wireless data transmitter that wirelessly transmits data indicative of the characteristic of the sample to the wireless data transceiver.

16. The system of claim 15 wherein the wireless data transceiver transmits the data to a computer over the wire.

17. The system of claim 10 wherein the wireless charging device further comprises a holding member for maintaining a predetermined spatial relationship between the handheld medical device and the wireless charging device.

18. The system of claim 10 wherein the handheld medical device further comprises a second holding member for maintaining the predetermined spatial relationship between the handheld medical device and the wireless charging device.

19. The system of claim 17 wherein at least one of the holding member and the second holding member includes a magnetic member.

20. A method for simultaneously wirelessly transmitting power to a handheld medical device and operating the handheld medical device, the method comprising:
wirelessly transmitting power to the handheld medical device using an antenna of a wireless charging device;
receiving power wirelessly, using an antenna of the handheld medical device, from the wireless charging device; and
simultaneously with the wireless receipt of power from the wireless charging device, measuring, using the handheld medical device, a characteristic of a sample of a bodily fluid while the handheld medical device is not connected by wire to any other device.

21. A system for monitoring one or more characteristics of a bodily fluid, the system comprising:
a wireless charging device that comprises:
a wireless power transmitter that receives power via a wire that is connected between the wireless charging device and an external power source and that wirelessly outputs power via an antenna;
a first wireless data transceiver configured to wirelessly receive data via an antenna; and
a Universal Serial Bus (USB) controller that transmits the data to a computer over the wire; and
a handheld diabetes management device that cannot be connected to another device or an external power source by wire and that comprises:
a re-chargeable battery;
a test strip port for receiving a test strip including a sample of blood;
a second wireless data transceiver configured to wirelessly receive data via an antenna;
a wireless power receiver that outputs power received wirelessly, via an antenna, from the wireless power transmitter;
a battery charging module that selectively charges the re-chargeable battery based on the power received wirelessly from the wireless power transmitter; and
a measurement module that measures a characteristic of the sample of blood simultaneously with the battery charging module charging the re-chargeable battery.
